(19) United States
(12) Patent Application Publication
(10) Pub. No.: US 2013/0024249 A1
(43) Pub. Date: Jan. 24, 2013

(54) PUBLIC TRANSPORT OPTIMIZATION

(71) Applicants: Zeev El Asher Adin Zohar, Herzlia (IL); Yehonatan Aumann, Jerusalem (IL); Shay Shafranek, Jerusalem (IL)

(72) Inventors: Zeev El Asher Adin Zohar, Herzlia (IL); Yehonatan Aumann, Jerusalem (IL); Shay Shafranek, Jerusalem (IL)

(21) Appl. No.: 13/639,326

(22) PCT Filed: Apr. 5, 2011
(86) PCT No.: PCT/IL11/00291

§ 371 Date: Oct. 4, 2012

Related U.S. Application Data
(60) Provisional application No. 61/321,889, filed on Apr. 8, 2010.
(60) Provisional application No. 61/323,565, filed on Apr. 13, 2010.

(51) Int. Cl. G01C 21/34; G06Q 50/30

(52) U.S. Cl. 705/13; 701/410

(57) ABSTRACT

A system and method for real time dispatching of vehicles taking into account multiple point to point transport requests and conditions including desired ride conditions, traffic, and infrastructure. Analysis of these factors is using suitable algorithms in order to determine optimal routes.

### BACKGROUND

1. Technical Field

Embodiments of the present invention relate generally to systems and methods for increasing the efficiency of vehicular transport, especially in relation to public transport scheduling.

2. Description of Related Art

Taxis provide for rapid, convenient transport between largely arbitrary points. However these generally are expensive compared to use of (for example) public transport. Large numbers of potential passenger seats remain unutilized at a given time, due to the large percent of time during which a taxi is ‘roaming’, looking for fares. Generally flagging a taxi is a haphazard affair, involving luck (if a taxi happens to pass and happens to be empty) or inconvenience (waiting for a taxi to arrive after ordering a pickup by phone). And finally, the large proportion of single riders (and consequent unutilized seating) is highly fuel inefficient and wasteful.

Hence, an improved method for point-to-point public transport is still a long felt need.

### BRIEF SUMMARY

According to an aspect of the present invention, there is provided a system and method for vehicle routing and dispatching.

It is further within provision of the invention to provide a method for vehicle dispatching for a plurality of riders, comprising steps of:
a. determining desired starting points and ending points for a number of riders;
b. determining routes allowing multiple riders to share vehicles;
c. dispatching vehicles upon said routes.

It is further within provision of the invention to provide a method for vehicle dispatching comprising steps of:
a. determining desired starting points, ending points, and ride conditions for a number of riders;
b. determining routes for a number of vehicles, wherein said routes connect subsets of said starting points to subsets of said ending points;
c. dispatching vehicles upon said routes;

It is within provision of the invention to provide the aforementioned method further charging said riders for said routes;

It is within provision of the invention to provide the aforementioned method further paying the drivers of said vehicles for executing said routes.

It is within provision of the invention to provide the aforementioned method wherein said step of determining desired starting points, ending points, and ride conditions for a number of riders is accomplished by orders submitted by means selected from the group consisting of: web interface; smartphone interface; cellphone interface; SMS message; voice call; touchtone phone interface; manual interface.

It is within provision of the invention to provide the aforementioned method wherein said ride conditions include trip duration limits, trip length constraints, willingness to ride with others, trip cost constraints.

It is within provision of the invention to provide the aforementioned method further wherein said step of determining routes is accomplished by means of minimizing a metric function of said routes.

It is within provision of the invention to provide the aforementioned method wherein said metric is defined in part by a function of cₛₕₐᵣₑ and c_{direct}, where cₛₕₐᵣₑ is the cost of shared routes, and c_{direct} is the cost of direct routes.

It is within provision of the invention to provide the aforementioned method wherein said metric is a function of parameters selected from the group consisting of: average route speed; route duration; number of passengers; route length; and route stops.

It is within provision of the invention to provide the aforementioned method wherein said minimizing of said metric function is accomplished by means of an algorithm using techniques selected from the group consisting of: gradient descent, simplex, convex minimization, neural networks, Bayesian networks, support vector machine, linear programming methods, nonlinear programming methods, Hessian methods, gradient methods, thermodynamic methods, entropic methods, and simulated annealing.

It is within provision of the invention to provide the aforementioned method wherein said step of charging said riders for said routes is accomplished by means of a pricing formula of the form:

$${P}_{shared} = {{P}_{direct} ( \frac{{T}_{direct}}{{T}_{shared}} )}^{β}$$

where P_{direct} is the cost of a direct unshared ride, P_{shared} is the cost of a shared ride, T_{direct} is a measure of the direct route, T_{shared} is a measure of the shared route, and β is a parameter of the system.

It is within provision of the invention to provide the aforementioned method where 0≦β≦1.

It is within provision of the invention to provide the aforementioned method where said measures T_{direct} and T_{shared} are selected from the group consisting of: route duration; route length; route congestion; and combinations thereof.

It is within provision of the invention to provide a method for vehicle dispatching for a plurality of riders, comprising steps of:
a. determining desired starting points and ending points for a number of riders;
b. determining routes allowing multiple riders to share vehicles;
c. dispatching vehicles upon said routes.

It is further within provision of the invention to provide a system for vehicle dispatching comprising:
a. a networked server;
b. means for receiving trip orders in electronic communication with said networked server, said trip orders including starting points, ending points, number of riders, and desired ride times;
c. an algorithm in communication with said server adapted to determine routes for a number of vehicles, wherein said routes connect subsets of said starting points to subsets of said ending points;
d. means for dispatching vehicles upon said routes;

It is within provision of the invention to provide the aforementioned method further charging said riders for said routes;

It is within provision of the invention to provide the aforementioned method further paying the drivers of said vehicles for executing said routes.

It is within provision of the invention to provide the aforementioned method wherein said means for receiving trip orders is accomplished by means selected from the group consisting of: web interface; smartphone interface; cellphone interface; SMS message; voice call; touchtone phone interface; manual interface.

It is within provision of the invention to provide the aforementioned method wherein said ride conditions include trip duration limits, trip length constraints, willingness to ride with others, trip cost constraints.

It is within provision of the invention to provide the aforementioned method further wherein said algorithm is adapted to minimize a metric function of said routes.

It is within provision of the invention to provide the aforementioned method wherein said metric is defined in part by a function of cₛₕₐᵣₑ and c_{direct}, where cₛₕₐᵣₑ is the cost of shared routes, and c_{direct} is the cost of direct routes.

It is within provision of the invention to provide the aforementioned method wherein said metric is a function of parameters selected from the group consisting of: average route speed; route duration; number of passengers; route length; and route stops.

It is within provision of the invention to provide the aforementioned method wherein said algorithm uses techniques selected from the group consisting of: gradient descent, simplex, convex minimization, neural networks, Bayesian networks, support vector machine, linear programming methods, nonlinear programming methods, Hessian methods, gradient methods, thermodynamic methods, entropic methods, and simulated annealing.

It is within provision of the invention to provide the aforementioned method wherein charging said riders for said routes is accomplished by means of a pricing formula of the form:

$${P}_{shared} = {{P}_{direct} ( \frac{{T}_{direct}}{{T}_{shared}} )}^{β}$$

where P_{direct} is the cost of a direct unshared ride, P_{shared} is the cost of a shared ride, T_{direct} is a measure of the direct route, T_{shared} is a measure of the shared route, and β is a parameter of the system.

It is within provision of the invention to provide the aforementioned method where 0≦β≦1.

It is within provision of the invention to provide the aforementioned method where said measures T_{direct} and T_{shared} are selected from the group consisting of: route duration; route length; route congestion; and combinations thereof.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates a high level system diagram for one embodiment of the invention;

FIG. 2 illustrates inputs and outputs of the analysis and optimization algorithm of the invention;

FIG. 3 illustrates the problem of a shorter direct route and a longer hared route connecting two points;

FIG. 4 illustrates a possible web interface for ordering rides through the invention;

FIG. 5 illustrates a possible smartphone interface for ordering rides through the invention;

FIG. 6 illustrates a possible payment scheme associated with operation of the invention;

FIG. 7 illustrates a flow chart for one embodiment of the invention;

and FIG. 8 illustrates inputs and outputs of the analysis and optimization algorithm of the invention.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system and method for driving optimization.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer (e.g., 1, 5, or 10).

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

Taxi fleets today are often equipped with advanced navigational equipment, such as GPS position broadcasting devices, two-way radios, and onboard computers equipped with navigation software and road databases. However despite the sophisticated equipment, the scheduling systems often remain largely as they were before the advent of GPS positioning. Often the only advance of a modern dispatcher over his predecessor is knowledge of cab position, which may be displayed in real time or near real time for instance on the dispatcher's computer screen. This allows a dispatcher to identify free cabs in a given area when a call for a fare in that area arises.

However as will be appreciated this advance while useful for the dispatcher, does not necessarily alleviate the burden of the fare to call and wait for a taxi, or otherwise relying on luck to flag down a passing free taxi. Furthermore it does not increase the number of passengers riding in taxis of a fleet at a given time.

With current levels of cellphone penetration, advanced networks such as 3G allowing wireless web browsing, and ubiquitous GPS positioning devices, all the tools are in place for a radical reworking of public transport scheduling/dispatching.

It is an object of the invention to provide a system and method for real time analysis of transport requests (such as taxi orders), transportation unit location (a ‘transportation unit’ being a vehicle available to transport passengers for some fee such as a taxicab; car service car, private bus, public bus, limo, or the like), traffic conditions, and infrastructure data (such as the information contained in electronically updated road maps). Analysis of these factors is undertaken in order to determine optimal routes and vehicles for passengers, allowing for increased vehicle usage and fewer vacant seats.

### Operation of the System

In one embodiment consistent with provisions of the invention, users indicate to a central server their transport requests. These requests may be transmitter over networks such as WiFi networks, cellular networks, and the internet in its various guises. Once a request has been transmitted to a server associated with the system, this service is in a position to correlate data from multiple system users, in order to provide shared rides from point to point.

For example, if two users need rides from approximately the same location and to locations along the same route, it is within provision of the invention to determine this confluence of needs and request a transportation unit to the pickup location(s). This transport unit request may be answered by any vehicle associated with the system, including private cars, fleet taxis, or the like. The transportation unit indicates its readiness to accept a fare, again by networked means, including WiFi, cellular network, and internet connectivity.

Each rider has only to indicate his current location and desired destination, and optionally further information such as desired or maximum fee, time constraints, desired stops along the route, and possibly further information. Any user with a 3G smartphone or the like can use the internet connectivity available through such devices in order to indicate these data. However the system is not limited to use by those in possession of such devices; for instance a user having only a simple cell phone can also indicate current position and desired destination by means of an SMS message of the form “at location 1, want location 2”, which syntax would be prearranged and advertised by the system operator. Alternatively and/or in addition, the system may use natural language processing to interpret free text user requests in a given natural language, which might take the form of “Current location is 34^{th} and 7^{th}, destination 110^{th} and Park” for example. Furthermore, voice requests are within provision of the invention, which would be routed through a human operator, or handled by a phone menu system (using touch tone phones), or by means of automated speech processing algorithms capable of interpreting human speech.

The server(s) of the system, which may be receiving multiple requests at any given time, will have at times a number of requests for point to point transport. Algorithms for optimized routing are employed to efficiently plan routes involving one or more passengers and two or more points on the map. Routes that involve shared legs (where more than one passenger is being served by the same vehicle) allow for higher efficiency, as do routes having the end of one ride to be near the start of the next. To generate routes with these desirable characteristics the following procedure is used. First a set of possible routes are generated. These routes may be either internally generated, or may be provided by external routing services. Ideally these routes provide routes between some or all of the start and end points, or points within a certain distance of these start and end points. A number pick-up and drop-off schedules are then computed, these schedules being rated or ranked using algorithms suitable for solving such problems. Generally speaking a metric can be defined that measures costs and benefits of given routes, and an optimization algorithm is then used to optimize this metric The costs may be based on such factors as the total amount of travel time, delays and detours encountered by the different passengers, number of empty seats for a given route, estimated fuel consumption, the costs per passenger mile, and more, while the benefits are based on such factors as the number of passengers taken to their destination, the estimated speeds of various routes, the discount experienced by the passengers, and the like. Once a suitable metric has been defined (in terms of some function of the aforementioned costs and benefits, as well as possible further factors), routes may be chosen based, in part, on known function optimization algorithms, including gradient descent, simplex, convex minimization, support vector methods, neural networks, Bayesian networks, linear programming methods, nonlinear programming methods, Hessian methods, gradient methods, thermodynamic methods, entropic methods, and simulated annealing, taboo and meta-search methods.

Once a route has been determined and a service vehicle has accepted the proposed route, the system may send a confirmation message to the riders in the form of an SMS, email, phone call, or the like as appropriate to the means available to the user.

### System Operation

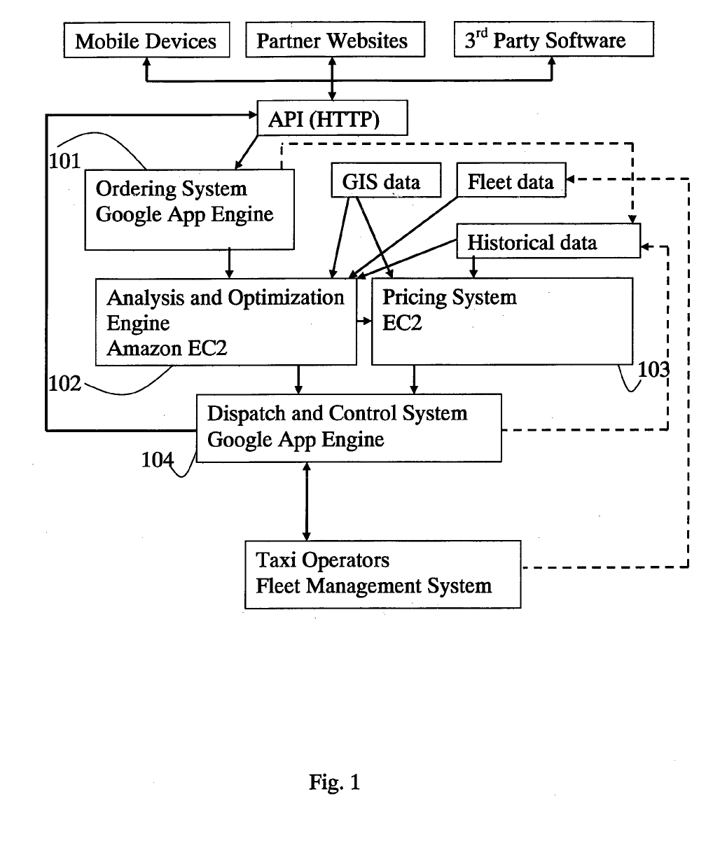

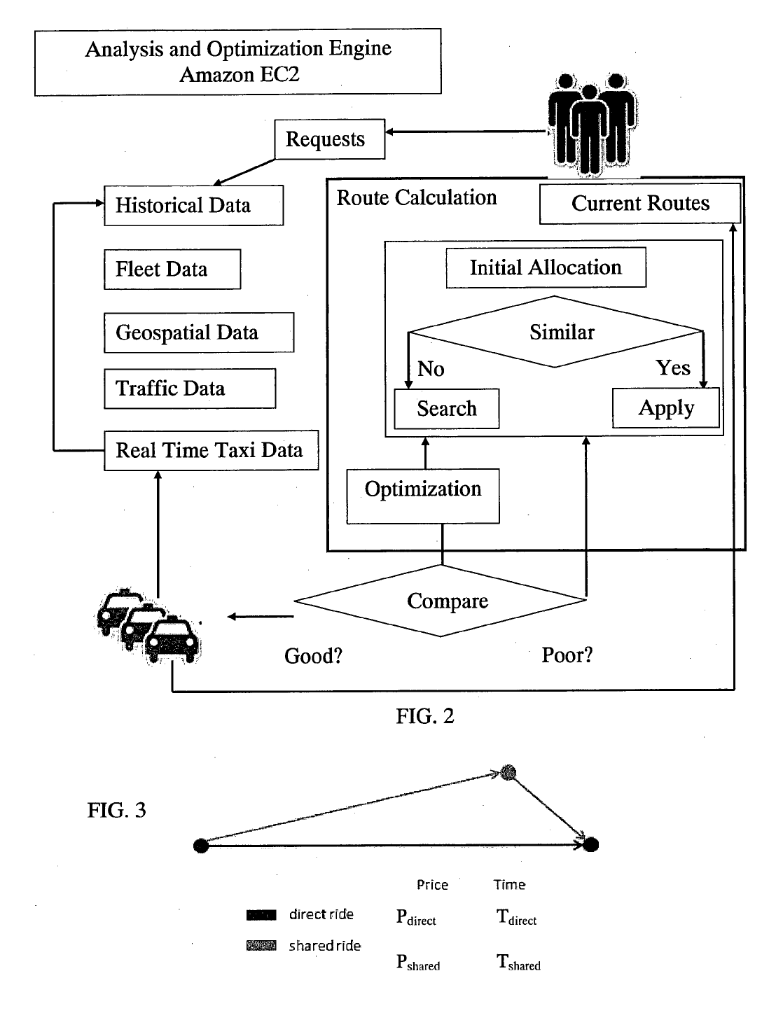

The operation of the dispatching/routing means of the invention is best understood with reference to the high level design diagram shown in FIG. 1. The system is built of several main components: the ordering system 101, the analysis and optimization engine 102, the pricing system 103, and the dispatch/control system 104.

The ordering system 101 receives orders from a variety of sources including but not limited to internet sites, email, cell phone calls, cell phone messages such as SMS messages, smartphones, and the like. The analysis and optimization engine 102 determines optimal routes in terms of time taken, number of seats utilized, number of passengers served, and the like. This engine 102 is in communication with the pricing system 103 which determines prices for the different passengers on a given route generated by the analysis engine 102, based on such factors as ride time, ride distance, number of passengers, waiting time, number of requested trips (or any other measure of ‘system pressure’, allowing for instance prices to rise when more people want rides), and passenger history (allowing for instance frequent riders to enjoy a discount or other promotional schemes, enabling prediction of future requests, and allowing for assessment of past performance of given routes). These systems 102, 103 are in communication with the dispatching system 104 which sends requests to the ‘service providers’ of the system, namely the cab drivers, service car drivers, taxi dispatchers, bus drivers, limo drivers and the like who have expressed interest in providing services to the system. Generally these service providers will profit from taking some percentage of the price paid by the passenger. This may be done either through the auspices of the system or directly by the service provider. For instance the passenger may be billed remotely by the system, thus avoiding any direct transfer of cash. The service provider will be credited with some amount of money by the system. Alternatively the service provider may take cash from the passenger, paying the system for use of its service and retaining a portion for his own services rendered.

The routing system may use any of the extant routing algorithms known in the art, including but not limited to meta-search, minimal spanning tree algorithms, A* search, administrative distance algorithms, arc routing, augmented tree-based routing, the B* search algorithm, credit-based fair queuing, diffusing update algorithm, Dijkstra's algorithm, distance-vector routing protocols, edge disjoint methods, the shortest pair algorithm, expected transmission count, the fairness measure, flooding, Floyd-Warshall algorithm, greedy forwarding, face routing, geographic routing, hierarchical state routing, IDA*, link-state routing, MCOP, MENTOR, max-min, ODMRP, optimized link state routing protocol, SMA*, temporally ordered routing, vehicular reactive routing, weighted fair queuing, and the like. It is further within provision of the invention to request routes between given pairs of points from external routing services or software, leveraging the existence of these services to reduce the computational requirements upon the system.

It is within provision of the invention the search algorithm or algorithms used by the analysis engine exploit parallel processing, linear efficiency, local search, taboo methods, learning systems, simulated annealing, and heuristics.

A key provision of the algorithm is the pricing method, which can be summarized in the following equation.

$${P}_{shared} = {{P}_{direct} ( \frac{{T}_{direct}}{{T}_{shared}} )}^{β}$$

Here P_{shared}, P_{direct} are the shared and direct prices, while T_{shared} and T_{direct} are the shared and direct trip durations. It is within provision of the invention to use a relation of this form, as well as related forms of quadratic or higher polynomial relations between the factors P_{shared}, P_{direct}, in general summarized by equations of the form

P_{shared}=f(P_{direct},T_{direct},T_{shared})

where f is an arbitrary function of the direct and shared durations. It is within provision of the invention to use either elapsed durations, estimated durations, elapsed mileage, estimated mileage, and combinations thereof in place of T_{shared} and T_{direct} in the above equations. These equations may be more fully understood in the context of an example such as that shown in FIG. 3. Here the direct and shared routes have different lengths; the direct route (carrying only one passenger) has a shorter duration (or length, or combination thereof) than the shared route, wherein the driver must make an additional stop along the way to pick up a second passenger. As the shared ride time will be greater than that of the direct time, the price to the system user (the rider) is made somewhat smaller than would otherwise be the case, by weighting the direct price with a function of the ratio between direct and shared route times. For the case of β=1 and a direct route being half the duration of the shared route, the shared price will be half the direct price.

At the heart of the system is the analysis/optimization engine, which is based on an algorithm tasked with minimizing the cost (or any other metric) of serving a variety of transportation requests. This is accomplished by optimizing the routes of the service fleet (e.g. fleet of taxis) to minimize the desired metric, in particular by sharing rides among the passengers, choosing routes such that the ending point of one routes is near the starting point of the next, and the like.

The input to the algorithm is a sequence of transportation requests which may be written in the form (r₁, r₂, r₃, . . . ). Each request rᵢ is an n-tuple of the form (sourceᵢ, destinationᵢ, number of passengersᵢ, request_timeᵢ, ride limitationᵢₗ, . . . ).

In most cases requests are provided online and in realtime, and the algorithm chooses the routes accordingly. In other cases, some requests may be provided ahead of time. These can be dealt with in the same fashion as the rest by the simple expedient of making the ‘request time’ parameter of the request quadruplet be the actual desired pickup time.

Additional inputs to the algorithm may include:
Fleet data: the number of service vehicles, the maximum number of passengers each service vehicle can carry (possibly different for different vehicles), working hours of the different drivers, etc.
Geospatial data: maps, shortest routes, speed limits, timings, etc.
Traffic data: historical and current traffic information.
Real time vehicle data: The current location of the service vehicles, requests actively being served, actual number of passengers on board.
Historical data: history of requests, route allocations, and actual performance data.

The output of the algorithm is a route and timing for each of the taxicabs, and a description, for each taxicab, of which passengers to pick-up and drop-off at each location. In certain cases it may also happen that requests are rejected, if they cannot be served with the given resources. In order to serve the requests, for each request rᵢ, there must be a taxicab that travels from sourceᵢ to destinationᵢ after timeᵢ with sufficient empty room for amountᵢ passengers. In addition, we may wish to pose additional service-level requirements. In particular, we may add a constraint on the maximum additional delay incurred by any passenger due to sharing the ride, as follows. For request rᵢ, let tᵢ^{direct} be the time it would take to serve the request in a direct fashion, without sharing, and let tᵢ^{share} the time it takes to serve the request using sharing—as provided by the algorithm. Then, we require that

tᵢ^{share}≦α·tᵢ^{direct},

where α is some multiplicative constant determined by external constraints. It is within provision of the invention to use different values of α for different service classes. It is within provision of the invention that other constraints be utilized. For instance it may be the case that a certain maximum delay is defined, and that the shared ride time be less than this maximum in all cases—thus leading to a requirement of the form

tᵢ^{share}≦min(α·tᵢ^{direct},β)

However we stress that the method of the invention is in fact ‘agnostic’ with respect to the particular constraint(s) chosen, as well as the metric to be optimized. Any set of constraints and metric can in fact be employed, and these factors (constraints and metric) can be chosen from a large library of potential candidates. It is further within provision of the invention that riders, drivers, and system operators may define their own ‘profiles’ of metrics to be optimized, for example by defining the economic cost of one's time; thus for example a rider in a hurry to catch a plane, where the cost of a cab ride is little object considering the cost of a lost plane ride, can then define a very high dollar value for his time, which will cause that rider's metric to reflect this value. It is further within provision of the invention that this high dollar value be reflected in the fare charged to said rider. The system performance overall can be analyzed to compare the performance of different constraints and metrics. This analysis can be performed on ‘real world’ data obtained through experiment, or by means of simulation, or both.

The goal of the algorithm is to optimize the savings due to sharing the cab direct among requests. Specifically, for each request rᵢ, let cᵢ^{direct} be the amount it would cost to serve the request using a regular (direct) taxi ride. Then, the baseline cost of the entire sequence is

$${c}^{direct} = {\sum }_{i} {c}_{i}^{direct}$$

On the other hand, for each taxicab j, let cⱼ^{share} be the cost of hiring the cab for the entire route determined for it by the algorithm. Then,

$${c}^{share} = {\sum }_{j} {c}_{j}^{share}$$

is the entire cost dictated by the algorithm.

The relative saving due to the sharing is thus

savings=c^{share}/c^{direct}

and it is this figure (for example) which we wish to optimize (in this case, reduce).

Obviously the above measure of savings is simply an example of a metric to be optimized; other metrics may be employed, including functions taking into account such factors as elapsed travel time, elapsed waiting time, cost to passengers, profit generated, fuel consumed, number of seats utilized, number of empty seats remaining, and the like.

As noted above once the metric above (save) has been defined the problem may be solved to some degree of optimization by a number of known algorithms. Since in this case the problem is a simple scalar function of a number of parameters, suitable algorithms include gradient descent, simplex, simulated annealing, neural nets, stochastic programming, variational methods, and the like.

The algorithm or algorithms find such solutions must be designed in a scalable way, allowing the handling of hundreds (possibly even thousands) of concurrent, active, calls. Thus, the running time of the algorithm is preferably efficient, e.g. linear or near linear in both the number of passengers and number of service vehicles. A high level description of the flow is provided in FIG. 1. The algorithm makes use of the geographical nature of the problem, which helps to reduce the combinatorial complexity of the problem by using local. For the optimization part, we use advanced local search techniques, such as tabu-search.

In addition, the algorithm uses component, which utilizes historical statistics and performance data to improve future optimizations. This is performed on two levels. First, the historical request data is used to predict and anticipate the upcoming requests. This allows to take into account requests even before than actually occur. In addition, historical performance data is used to fine tune the algorithm and avoid mistakes.

As an example of the possible benefits that may be enjoyed by the system we consider an example of an hour in the day of a taxi driver. The driver takes a fare on a 20 minute journey, then waits 24 minutes until picking up his next fare. More than 50% of the drivers time is unutilized, and in a majority of cases the driver takes a single passenger; thus on average this driver has a passenger seat occupancy of less than half a seat usage. In New York City, a fare would pay 10.5 dollars for the 20 minute ride. The driver makes about 6.3 dollars on this fare after paying for gas, medallion, tax, etc.

If on the other hand we increase the seat occupancy to 1.3, by means of (for instance) 4 riders in an hour, we can allow the passengers to pay far less, as little as $4.70, while the driver earn far more. As the seat occupancy increases the rider fee decreases, eventually reaching a level where the rider pays fees comparable to public bus fares, while receiving point to point (aka door to door) service.

It is within provision of the invention that modern payment methods be used including debit cards, digital cash, ecash, virtual credit, credit cards, vouchers, coupons, cash, tokens, digital tokens, and the like.

As most fares in modern metropolitan centers are booked ahead of time by phone, the current system can easily be used instead of current phone booking systems. For example, a system operator can take phone calls and manually enter location and destination data into computer, to be uploaded to (or directly used by) the server(s) of the invention. Alternatively, an automated menu system may take calls and process them, either through touch tone menus, voice recognition software, or a combination of the two. Finally as mentioned above, SMS messages may be used to indicate location and destination data. Obviously those potential riders having internet connectivity can use the system directly through the net, for example by means of a web interface allowing for entry of location and destination data. In the case of smartphones with GPS receivers, available GPS data can be used to prevent the need for a user to enter his/her current location.

It is within provision of the invention to use scalable design for the server elements of the system, allowing the system to handle any number of users with equal aplomb. The system uses three cloud resources; computing, storage, and service.

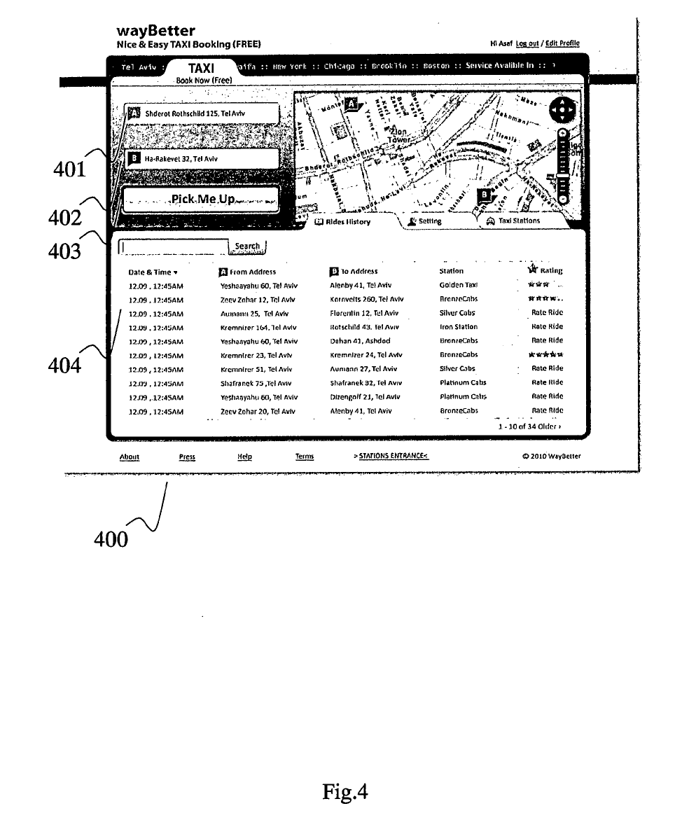

An example of a web-based interface to the system is shown in FIG. 4. Here a web page 400 is used to provide information concerning the system and allow user interaction with the system. Input fields 401, 402 allow a user to enter two map points labeled in this case A and B, which may correspond for instance to current location and desired destination. A ‘pick me up’ button 403 allows the potential rider to request a pickup at his current location. A list of currently request rides 404 allows the users to see what other users are requesting similar rides. This list may be filtered by various criteria or metrics as described above, for example in order of how close the pickup points are spatially, how close they are time-wise, how close the destination points are physically, how close they are time-wise, combinations of these. A more appropriate metric may be how close a given route including the pickup of a second passenger is, to the direct route between that a cab could otherwise take between the users current and desired locations.

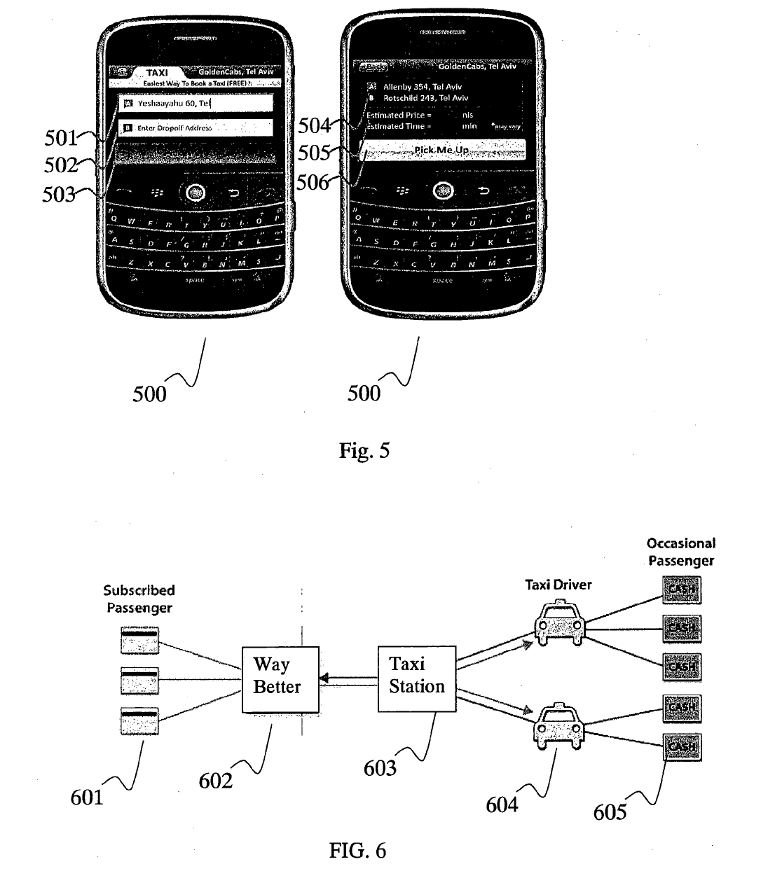

An example of a smartphone-based interface to the system is shown in FIG. 5. Here a smartphone 500 is used to provide information concerning the system and allow user interaction with the system. Input fields 501, 502 allow a user to enter two locations labeled in this case A and B, which may correspond for instance to current location and desired destination. A ‘pick me up’ button 503 allows the potential rider to request a pickup at his current location. Once the input fields are completed, a second screen can be displayed showing for instance the entered current and desired locations 504, as well as other information such as estimated price, estimated pickup time, estimated trip duration, estimated arrival time, number of pickups along the way, names of passengers being picked up, and the like.

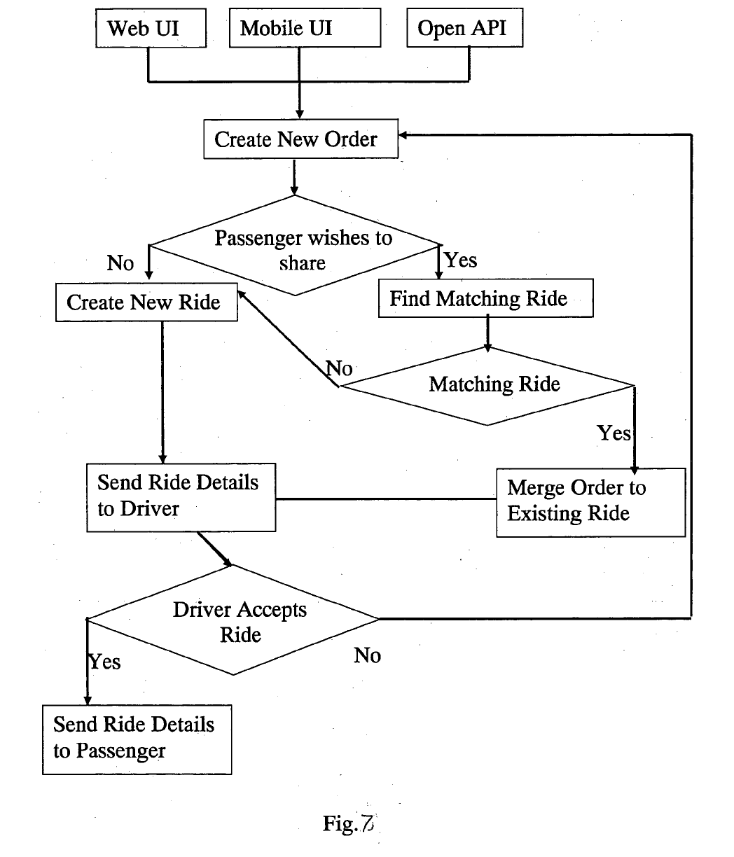

An example of a possible payment system is shown in FIG. 6. Here a number of subscribed passengers 601 are regular users of the system and thus have established payment means such as by way of credit card, bank transfer, online transfer or the like.

These users are in communication with the server of the system 602 and through this server can order rides, which may be unique or recurring events. The server 602 is in communication with one or more taxi stations 603 which are dispatched to make the trips requested by the subscribers 601. Occasional passengers 605 who also use the system need not have special payment means, and can simply pay in cash. The amount of the transaction can be recorded by the system, or can be transparent; in either case the taxi driver will in general pay the system operator some fraction of his income, on a per-ride, per-mile, per time or mixed basis.

It is within provision of the invention to integrate with popular websites, mapping and navigation applications, central web portals, search engines, and the like. It is within provision of the invention to provide a standard API for online ride booking.

It is within provision of the invention to allow for large-event scenarios, for example conferences, concerts or the like. In these cases large numbers of people will need transport, e.g. from the train station nearest a rock concert arena, to the arena itself. In this case the system can predict or in manual fashion be ‘primed’ for the event by ordering large numbers of service providers (taxis, buses, cabs, etc.) to the most likely pickup point(s).

A simple system diagram of one implementation consistent with the invention is shown in FIG. 7. Here a number of interfaces send orders to the ‘create new order’ node, including Web sources, mobile phone sources, and others as allowed for by open programmer interfaces, which allow third party programmers to request orders. The order specifies (amongst other parameters) whether the rider wishes to share the ride. If not, the new ride order is created, ride details are sent to a driver, and the driver can accept or refuse the ride. If the driver accepts the ride, the ride details are sent to the passenger and the driver can then pick up the passenger. If the driver refuses the ride, the passenger order is reinserted into the system, creating a ‘wish to share’ event as before.

If on the other hand the rider specifies that he/she wishes to share the ride, the ride-matching algorithm is used to find a matching ride. If a matching ride is indeed found, the rider is merged to the existing order and the details are sent to the driver who may accept or refuse the order. If no matching ride is found, a new ride order is created.

1-56. (canceled)

57. A method of vehicle dispatching for serving a plurality of riders, comprising steps of:
a. determining desired starting points and ending points for said riders;
b. determining routes allowing multiple riders to share vehicles;
c. dispatching vehicles upon said routes.

58. The method of claim 57 further comprising a step of determining desired ride conditions for said riders.

59. The method of claim 58 wherein said ride conditions are selected from the group consisting of: trip duration limits, trip length constraints, willingness to ride with others, trip cost constraints.

60. The method of claim 57 further charging said riders for said routes and paying the drivers of said vehicles for executing said routes.

61. The method of claim 57 wherein said step of determining desired starting points and ending points for a number of riders is accomplished by means selected from the group consisting of: web interface; smartphone interface; cellphone interface; SMS message; voice call; touchtone phone interface; manual interface.

62. The method of claim 57 further wherein said step of determining routes is accomplished by means of minimizing a metric function of said routes.

63. The method of claim 57 wherein said metric is defined in part by a function of the cost of shared routes, the cost of direct routes, average route speed, route duration, number of passengers, route length, and route stops.

64. The method of claim 63 wherein said step of minimizing said metric function is accomplished in part by means of an algorithm using techniques selected from the group consisting of: gradient descent, simplex, convex minimization, neural networks, Bayesian networks, support vector machine, linear programming methods, nonlinear programming methods, Hessian methods, gradient methods, thermodynamic methods, entropic methods, simulated annealing, Taboo search, and meta-search.

65. The method of claim 61 wherein said step of charging said riders for said routes is accomplished by means of a pricing formula of the form:
$${P}_{shared} = {{P}_{direct} ( \frac{{T}_{direct}}{{T}_{shared}} )}^{β}$$
where P_{direct} is the cost of a direct unshared ride, P_{shared} is the cost of a shared ride, T_{direct} is a measure of the direct route, T_{shared} is a measure of the shared route, and β is a parameter of the system.

66. The method of claim 65 where said measures T_{direct} and T_{shared} are selected from the group consisting of: route duration; route length; route congestion; and combinations thereof.

67. A system for vehicle dispatching for a plurality of riders, comprising:
a. a networked server;
b. means for determining desired starting points and ending points for a number of riders, said means in electronic communication with said server;
c. an algorithm in communication with said server adapted to determine routes allowing multiple riders to share vehicles;
d. means for dispatching vehicles upon said routes.

68. The system of claim 67 further comprising means for determining desired ride conditions for said riders and ride conditions based on trip duration limits, trip length constraints, rider willingness to ride with others, and trip cost constraints.

69. The system of claim 67 further comprising means for charging said riders for said routes.

70. The system of claim 67 wherein said means for receiving trip orders is accomplished by means selected from the group consisting of: web interface; smartphone interface; cellphone interface; SMS message; voice call; touchtone phone interface; manual interface.

71. The system of claim 67 further wherein said algorithm is adapted to minimize a metric function of said routes defined in part by a function of the cost of shared routes, the cost of direct routes.

72. The system of claim 71 wherein said metric is a function of parameters selected from the group consisting of: average route speed; route duration; number of passengers; route length; and route stops.

73. The system of claim 69 wherein charging said riders for said routes is accomplished by means of a pricing formula of the form:
$${P}_{shared} = {{P}_{direct} ( \frac{{T}_{direct}}{{T}_{shared}} )}^{β}$$
where P_{direct} is the cost of a direct unshared ride, P_{shared} is the cost of a shared ride, T_{direct} is a measure of the direct route, T_{shared} is a measure of the shared route, and β is a parameter of the system.

74. The system of claim 73 where 0≦β≦1.

75. The system of claim 73 where said measures T_{direct} and T_{shared} are selected from the group consisting of: route duration; route length; route congestion; and combinations thereof.

76. The system of claim 69 wherein charging said riders for said routes is accomplished by means of a pricing formula of the form:
P_{shared}=f(P_{direct},T_{direct},T_{shared})
where P_{direct} is the cost of a direct unshared ride, P_{shared} is the cost of a shared ride, T_{direct} is measure of the direct route, T_{shared} is a measure of the shared route.
